(19) United States
(12) Patent Application Publication
(10) Pub. No.: US 2006/0251186 A1
(43) Pub. Date: Nov. 9, 2006

(54) Wireless communication receiver having an adc with a limited dynamic range

(76) Inventor: Xuecheng Qian, Shanghai (CN)

Correspondence Address: PHILIPS INTELLECTUAL PROPERTY & STANDARDS, P.O. BOX 3001, BRIARCLIFF MANOR, NY, 10510, US

(21) Appl. No.: 10/556,249

(22) PCT Filed: Apr. 16, 2004
(86) PCT No.: PCT/IB04/50467

§ 371 Date: Nov. 10, 2005

(30) Foreign Application Priority Data
May 16, 2003 (CN) 03131365.5

(51) Int. Cl. H04L 27/00

(52) U.S. Cl. 375/316

(57) ABSTRACT

The present invention provides a low cost receiver by reducing the required dynamic range of the ADC in a wireless communication receiver, without degrading the receiver performance. In the wireless communication receiver of the invention, a digital filter is used to filter digital signals from the ADC to attenuate residual interferers in the digital signals by a predetermined amount (e.g., more than that prescribed in a technical specification). This allows relaxation of tolerable quantization noise generated by the ADC to a pre-defined level to thereby substantially reduce a dynamic range of the ADC. This pre-defined level of quantization noise is higher than a level prescribed by the receiver's sensitivity, while the total interference of the receiver is kept at a level not greater than an allowable level. Thus, the ADC has a word length that corresponds to the reduced dynamic range. Accordingly, not only the cost of the ADC is decreased, the costs of all signals processing modules following the ADC are also decreased, resulting in a substantial reduction in the overall cost of the receiver.

### BACKGROUND OF THE INVENTION

The invention relates generally to wireless communication devices, and more particularly to wireless communication receivers, such as radio frequency (RF) receivers.

Wireless communications technology has brought much convenience to people's life. For example, cellular phones have been very popular and widely used by many people. As the number of wireless equipment increases, mutual interferences between different equipment is of an increasing concern with respect to both the system configurations and the designs of wireless equipment. In designing wireless equipment, it is necessary to have the receiver attenuate all possible interferers to a sufficiently low level in order to achieve a required signal to-interference ratio (SIR) for quality communications.

FIG. 1 shows a conventional RF receiver 10, which includes a processing unit 15, an n-bit analog-to-digital converter (ADC) 52, and a demodulator 62. In processing unit 15, signals received by an antenna 11 are filtered by a RF band-pass filter 12 to ensure that only the wanted signal passes through while the strong interferers far away on the frequency band from the wanted signal are attenuated. A low noise amplifier (LNA) 16 amplifies the weak signal received. Then mixers 22 and 36 convert the wanted signal from RF to baseband by mixing it with frequency signals f₁ and f₂ respectively. An intermediate frequency (IF) filter 32 also attenuates the out-of-band interferers to some extent. At baseband, an analog low-pass filter 42 removes most of the out-of-band interferers and noise power to increase the SIR. An automatic gain control (AGC) unit 46 adjusts its input signal into a limited dynamic range (DR), so that ADC 52 with a limited word length can be used to convert the analog signal into a digital signal. Thereafter, a demodulator 62 de-spreads and decodes the digital signal to recover the transmitted user data.

In order to achieve the required SIR, the interference (I) component should be maintained within a tolerable range. The interference at the input of demodulator 62 mainly comprises the residual external interferers and the receiver noise, which includes the circuit noise from all the components in the receiver and the ADC quantization noise generated during the sampling operation. The circuit noise remains substantially constant, while the ADC quantization noise is specified by the receivers sensitivity and usually contributes little to the overall receiver noise.

An Important feature of the ADC is its word length which specifies the number of bits for each sampling of the input signal. The word length depends on the dynamic range requirement of the ADC. The lower limit of the dynamic range is specified by the equivalent quantization noise level as prescribed by the receiver sensitivity and the required SIR, while the upper limit is specified by the equivalent peak power of the ADC input. In a receiver in which the out-of-band interferer is not sufficiently attenuated by the analog filters, the residual interferer also has influence on the peak power at the ADC input. In some cases, the residual interferer may be much stronger than the wanted signal and receiver noise, and therefore its power level specifies the equivalent peak power of the ADC input. In such cases, the dynamic range required for the ADC is greatly increased, since the specified equivalent quantization noise remains at a very low level. This causes an substantial increase to the overall cost of the receiver, since not only the cost of the ADC is increased as a result of an increase in its word length, the costs of all the signal processing modules following the ADC (e.g., the demodulator) have to be increased to accommodate the complexities in handling the resulting larger digital data output from the ADC.

FIG. 2 illustrates an example in connection with a conventional receiver, with reference to the TD-SCDMA specification. In this example, the equivalent receiver noise is −104.15 dBm and the specified equivalent quantization noise is at −119.15 dBm, which is much lower than the overall receiver noise. The maximum specified power level of an adjacent channel interferer is −54 dBm and is suppressed by the analog filters to −76 dBm. This residual interferer may be further suppressed by a digital filter to −87.24 dBm. Taking into consideration of a known peak-to-average ratio of 12 dB, the peak power of the equivalent the ADC input is −64 dBm. Therefore, the required dynamic range of the ADC Is the difference between −64 dBm and −119.15 dBm, i.e., 55.15 dB. This usually translates to an equivalent word length between 8 to 10 bit long. As described above, the longer the ADC's word length is, the higher the overall receiver's cost is.

Therefore, there is a need to provide a low cost receiver without degrading the performance.

### SUMMARY OF THE INVENTION

The present invention provides a low cost receiver by reducing the required dynamic range of the ADC in a wireless communication receiver, without degrading the receiver performance.

According to one embodiment of the invention, a wireless communication receiver is provided. The receiver comprises a processing unit, an analog-to-digital converter (ADC), and a digital filter. The processing unit processes received signals and filters the processed signals in an analog domain to output filtered analog signals. The ADC converts the filtered analog signals into digital signals. Then, the digital filter filters the digital signals from the ADC and attenuates residual interferers in the digital signals by a predetermined amount (e.g., more than that prescribed in a technical specification). This allows relaxation of tolerable quantization noise generated by the ADC to a pre-defined level to thereby substantially reduce a dynamic range of the ADC. This pre-defined level of quantization noise is higher than a level prescribed by the receivers sensitivity, while the total interference of the receiver is kept at a level not greater than an allowable level. Thus, the ADC has a word length that corresponds to the reduced dynamic range.

Accordingly, not only the cost of the ADC is decreased, the costs of all the signal processing modules following the ADC are also decreased, resulting in a substantial reduction in the overall cost of the receiver.

Other objects and attainments together with a fuller understanding of the invention will become apparent and appreciated by referring to the following description and claims taken in conjunction with the accompanying drawings.

### BRIEF DESCRIPTION OF THE DRAWINGS

The invention is explained in further detail, and by way of example, with reference to the accompanying drawings wherein:

FIG. 1 shows a conventional RF receiver;

FIG. 2 illustrates an example in connection with a conventional receiver;

FIG. 3 shows a wireless communication receiver according to one embodiment of the invention;

FIG. 4 illustrates an example of reducing the dynamic range of an ADC for a handset receiver in accordance with one embodiment of the invention; and

FIG. 5 illustrates a transfer function of a digital filter In accordance with one embodiment of the invention.

Throughout the drawings, the same reference numerals indicate similar or corresponding features or functions.

### DETAILED DESCRIPTION OF THE PREFERRED EMBODIMENTS

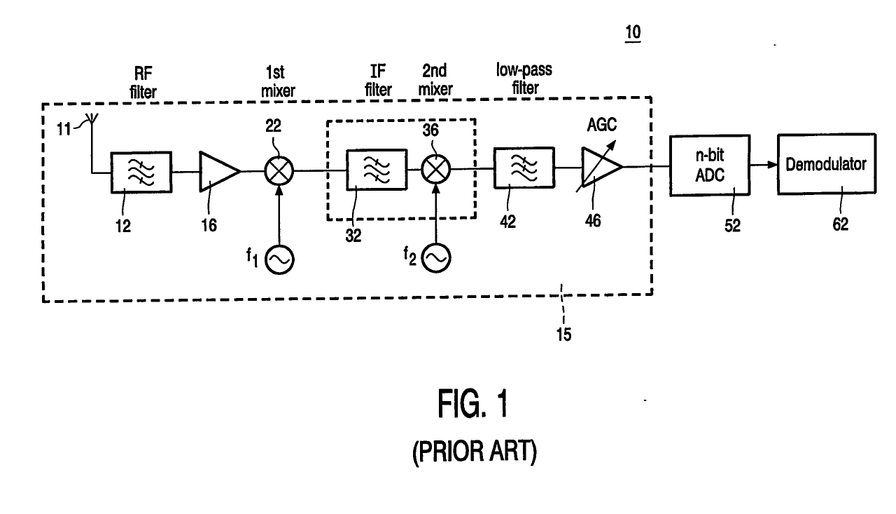

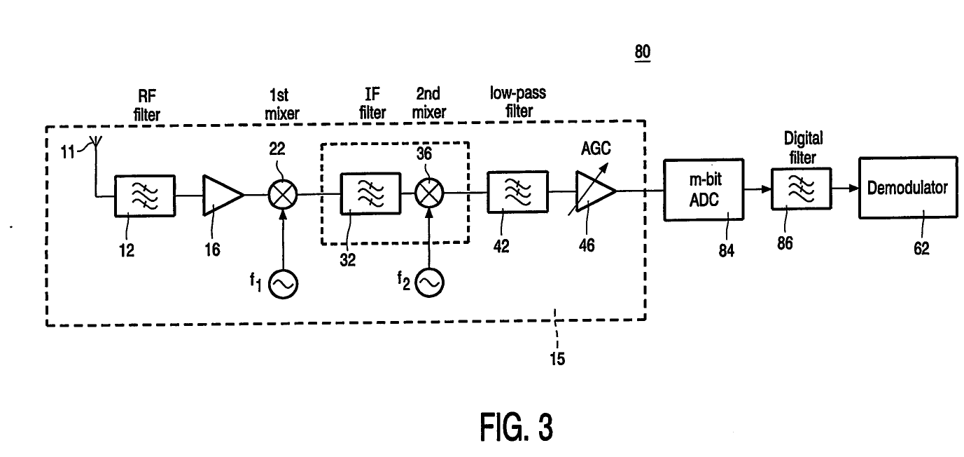

FIG. 3 shows a wireless communication receiver 80 according to one embodiment of the invention. Receiver 80 includes a processing unit 15, an m-bit ADC 84, a digital low-pass filter 86, and a demodulator 62. Processing unit 15 performs a number of functions including mixing and filtering signals in the same manner as previously described in connection with FIG. 1. Digital low-pass filter 86 further attenuates the out-of-band interferers to a level lower than that prescribed In the technical specifications. This allows relaxation of the equivalent quantization noise level of the ADC to a higher level than that prescribed by the receiver sensitivity without changing the receiver's SIR. Thus, a much smaller dynamic range is achieved for ADC 84, resulting in a substantial decrease in the word length of ADC 84, and thus the overall cost of the receiver.

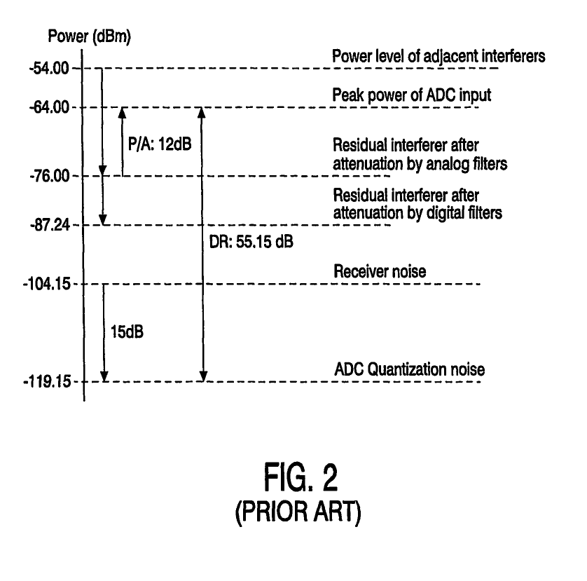

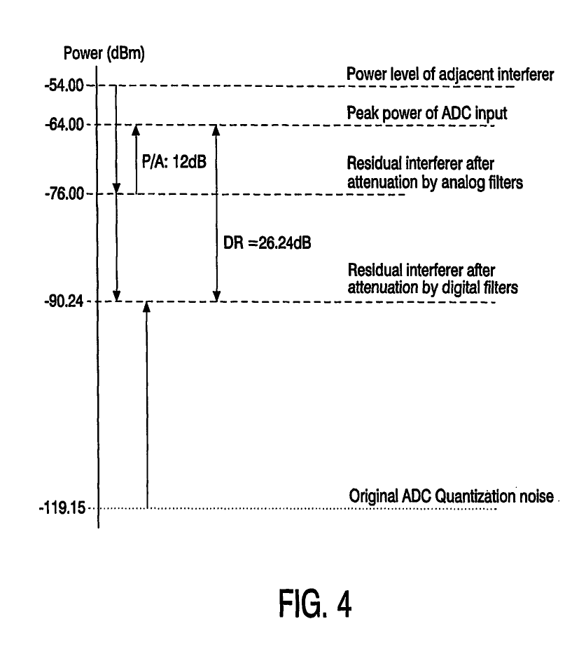

FIG. 4 illustrates an example of reducing the dynamic range of an ADC for a handset receiver, such as receiver 80, in accordance with one embodiment of the invention. Compared to the example In FIG. 2, this example uses similar data prescribed in the TD-SCDMA specification. In the example, the residual adjacent interferer is suppressed in the digital domain by 14.24 dB, which is 3 dB more than that in FIG. 2. Since the total allowable interference (I) (including both the residual interference and the receiver noise) is to remain constant and the residual interference has been further decreased, the total receiver noise may be relaxed to a higher level. As the front-end noise and the ADC circuit noise in the total receiver noise are almost constant under the normal circumstances, the ADC quantization noise, which is normally at a very low level, can thus be significantly relaxed to a higher level. Thus, the permissible quantization noise of the ADC is greatly relaxed to −90.24 dBm, maintaining the overall SIR at a constant level. Of course, in an actual implementation, the equivalent quantization noise level can be lower than the tolerable level of −90.24 dBm. As a result, the required dynamic range for the ADC is reduced to 26.24 dB, i.e., the difference between −64 dBm and −90.24 dBm, which is significantly lower than 55.15 dB in the example of FIG. 2. Therefore, the corresponding word length of the ADC can be reduced by 5 quantization bits compared to that illustrated in FIG. 2, resulting in a substantial decrease in the costs of all the signal processing modules following the ADC and thus the overall cost of the receiver.

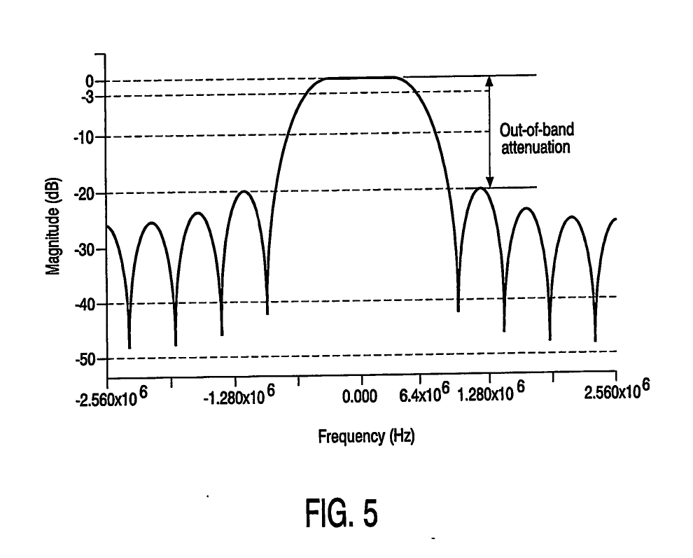

FIG. 5 illustrates the transfer function of digital filter 86 in accordance with one embodiment of the invention.

In the above, the invention has been illustrated in connection with a RF receiver in a mobile terminal. The invention can also be used in a receiver of other wireless communication systems, e.g., a base station, a digital TV receiver, etc.

While the invention has been described in conjunction with specific embodiments, it is evident that many alternatives, modifications and variations will be apparent to those skilled in the art in light of the foregoing description. Accordingly, it is intended to embrace all such alternatives, modifications and variations as fall within the spirit and scope of the appended claims.

1. A wireless communication receiver, comprising:
(a) a processing unit that processes received signals and filters the processed signals in an analog domain to output filtered analog signals;
(b) an analog-to-digital converter (ADC) that converts the filtered analog signals into digital signals; and
(c) a digital filter that filters the digital signals from the ADC and attenuates residual interferers in the digital signals by a predetermined amount, so as to allow relaxation of tolerable quantization noise generated by the ADC to a pre-defined level to thereby substantially reduce a dynamic range of the ADC;
wherein the ADC has a word length corresponding to the reduced dynamic range.

2. The receiver of claim 1, wherein the pre-defined level is higher than a level prescribed by the receiver's sensitivity.

3. The receiver of claim 1, wherein the pre-defined level of the quantization noise is maintained within a range, such that the total interference of the receiver is kept at a level not greater than an allowable level.

4. The receiver of claim 1, further comprising a demodulator that demodulates the filtered digital signals from the ADC to recover user data.

5. A method for use in a wireless communication receiver, the method comprising the steps of:
processing received signals;
filtering the processed signals in an analog domain to output filtered analog signals;
converting the filtered analog signals into digital signals; and
filtering the digital signals in a digital domain to attenuate residual interferers in the digital signals by a predetermined amount, so as to allow relaxation of tolerable quantization noise generated at the converting step to a pre-defined level to thereby substantially reducing the number of quantization bits required at the converting step;
wherein the converting step converts the filtered analog signals into the digital signals with a corresponding reduced number of quantization bits.

6. The method of claim 5, wherein the pre-defined level is higher than a level prescribed by the receiver's sensitivity.

7. The method of claim 5, wherein the pre-defined level is maintained within a range, such that the total interference of the receiver is kept at a level not greater than an allowable level.

8. The method of claim 5, further comprising a step of demodulating the filtered digital signals to recover user data.
